(19) United States
(12) Patent Application Publication
(10) Pub. No.: US 2008/0090123 A1
(43) Pub. Date: Apr. 17, 2008

(54) FUEL CELL HAVING STACK WITH IMPROVED SEALING STRUCTURE

(75) Inventors: Jie PENG, Yongin-si (KR); Tai-won Song, Yongin-si (KR); Seung-jae Lee, Yongin-si (KR); Jae-young Shin, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/684,825

(22) Filed: Mar. 12, 2007

(30) Foreign Application Priority Data
Oct. 12, 2006 (KR) 2006-99424

(51) Int. Cl. H01M 8/04

(52) U.S. Cl. 429/26; 429/34

(57) ABSTRACT

A fuel cell stack having a sealing structure for sealing gasses and cooling water. The sealing structure is also electrically insulative. The fuel cell stack includes O-ring beds that are combined to the gas flow plates and through which liquid flow holes cooling water passes, gaskets that surround the gas flow plate to prevent the leakage of the gasses, and O-rings that surround the flow channels of the cooling plates and the O-ring beds to prevent the leakage of the cooling water. Manufacturing costs of the sealing structure are reduced while production efficiency is increased.

### CROSS-REFERENCE TO RELATED PATENT APPLICATIONS

This application claims the benefit of Korean Application No. 2006-99424, filed Oct. 12, 2006, in the Korean Intellectual Property Office, the disclosure of which is incorporated herein in its entirety by reference.

### BACKGROUND OF THE INVENTION

1. Field of the Invention

Aspects of the present invention relate to a fuel cell stack made by stacking gas flow plates and cooling plates, and more particularly, to a fuel cell having a stack in which a sealing structure for sealing a gas and cooling water is improved.

2. Description of the Related Art

A fuel cell is an electricity generator that changes chemical energy of a fuel into electrical energy through a chemical reaction, and the fuel cell can continuously generate electricity as long as the fuel is supplied. FIG. 1 is a schematic drawing illustrating the energy transformation structure of a fuel cell. Referring to FIG. 1, when air that includes oxygen is supplied to a cathode 1 and a fuel containing hydrogen is supplied to an anode 3, electricity is generated by the recombination of water through an electrolyte membrane 2. The anode 3 catalytically splits hydrogen into positively charged hydrogen ions and negatively charged electrons. The electrolyte membrane 2 only allows the positively charged hydrogen ions to pass, forcing the negatively charged electrons to flow through an external circuit thereby producing current. The positively charged hydrogen ions and the negatively charged electrons recombine with oxygen at the cathode 1 to form water. However, generally, the electricity generated by a unit cell does not have a high enough voltage to be useful. Therefore, electricity is generated from a plurality of unit cells connected in series in the form of a stack.

FIG. 2 is an exploded perspective view illustrating a conventional connection structure of unit cells from which a fuel cell stack is made. Referring to FIG. 2, a unit cell of a stack includes a cathode 1, an anode 2, and an electrolyte membrane 2 arranged such that the electrolyte membrane 2 is disposed between the cathode 1 and the anode 2. The cathode 1, anode 3, and the electrolyte membrane 2 are stacked in such a way to form a membrane electrode assembly (MEA) 10. Each MEA 10 is disposed between a pair of gas flow plates 20. The gas flow plates 20 further include bipolar plates 20a and monopolar plates 20b. The generation of electricity through the MEA 10 generates heat. As such, cooling plates 30 are provided between generally every fifth or sixth unit fuel cell. A fuel cell stack is formed by repeating and stacking the above-described structure.

Reaction flow channels 21 to supply hydrogen and oxygen to the anode 3 and the cathode 1, respectively, are formed on both surfaces of the bipolar plates 20a. Therefore, hydrogen and oxygen supplied from the outside are supplied to each of the anode 3 and the cathode 1 through the reaction flow channels 21. A cooling plate 30 is installed for cooling the heat generated during the electricity generation process. That is, in the process of electrochemical reaction, heat is generated as well as electricity. For smooth operation of the fuel cell, the fuel cell must be continuously cooled by removing heat. For this purpose, in the fuel cell stack, as depicted in FIG. 2, a cooling plate 30 that passes cooling water for heat exchange is mounted between about every 5th and 6th unit cell. The cooling plates 30 can be bipolar to supply both fuel and cooling water to the next adjacent unit cell or monopolar. The cooling water absorbs heat in the fuel cell stack while passing through flow channels 31 of the cooling plate 30, and the cooling water that absorbs heat is cooled in the heat exchanger (not shown) by secondary cooling water, and is circulated back to the stack. The gas flow plates 20, as described above, include the monopolar plates 20b. The monopolar plates 20b provide reaction flow channels 21 on only one side of the monopolar plates 20b. In particular, the monopolar plates 20b that directly contact the flow channels 31 of the cooling plates 30 have reaction flow channels 21 formed only on a surface opposite the surface that contacts the flow channels 31. And thus, the monopolar plate 20b is described as monopolar. Here, the bipolar plates 20a and the monopolar plates 20b altogether are called as gas flow plates 20.

A gasket 40 that seals the reaction flow channels 21 is attached between the gas flow plates 20 to prevent hydrogen and oxygen from leaking to the outside. O-rings 50 are also mounted between the monopolar plates 20b and the cooling plates 30 to prevent a fluid from leaking to the outside. That is, when the gas flow plates 20 are stacked with each other, after mounting the MEA 10 and the gasket 40 in between the gas flow plates 20, the gasket 40 is attached to the gas flow plates 20 along the edges to prevent the gasses from leaking. And, the O-rings 50 are mounted between the cooling plates 30 and the monopolar plates 20b to prevent the cooling liquid from leaking. In this way, a conventional sealing structure for preventing the leaking of fluid is made when the unit cells are combined into a fuel cell stack.

A major problem of the conventional fuel cell structure is that there is approximately 100 times more pressure in the flow channels 31 than the reaction flow channels 21. Specifically, the pressure of hydrogen and oxygen is only about 5 kpa, but the pressure of cooling water reaches about 500 kpa. The O-rings 50 can endure the high pressure as the O-rings 50 are manufactured with the expectation that the O-rings 50 would be subjected to such pressures. However, the gasket 40, which mainly functions to prevent gasses from leaking, is manufactured based on the expected gas pressures. Therefore, there is a risk of the higher pressure cooling water leaking through the gasket 40. In particular, manufacturing the O-rings 50 is not difficult as the O-rings 50 have simple loop shapes; but the gaskets 40 must be manufactured in a sheet identical to the shape of each of the plates. That is, the design of the gasket 40 can impose production costs and difficulties on the manufacture of the gasket 40. In addition, as the gaskets 40 are exposed to the flowing cooling water, the gaskets 40 must be manufactured to withstand both low pressures and high pressures simultaneously. If the gasket 40 is manufactured using the same material and thickness as the O-ring 50, manufacturing cost of the gasket 40 is prohibitively expensive.

Furthermore, there is electrical leakage of electricity generated from the MEA 10 through the cooling water that passes through the gas flow plate 20. That is, a portion of electricity generated from the MEA 10 is leaked through the cooling water, which is an electrical conductor, thereby reducing the efficiency of power generation.

Accordingly, there is a need to develop a sealant technology for fuel cell stacks to provide both physical and electrical sealing for areas of greatly varying pressures.

### SUMMARY OF THE INVENTION

Aspect of the present invention provide a fuel cell having a sealing structure that can effectively prevent leakage of a gas and cooling water between which exists a large pressure difference.

Aspects of the present invention also provide a fuel cell having a sealing structure that can effectively prevent leakage of electricity through cooling water.

According to an aspect of the present invention, there is provided a fuel cell having a stack comprising: a membrane electrode assembly (MEA) where a power generation reaction occurs; gas flow plates on which flow channels to supply gasses to be supplied to the electrodes are formed; cooling plates on which cooling flow channels for cooling heat generated from the power generation reaction are formed; O-ring beds that are combined to the gas flow plate and has a liquid flow hole through which the cooling water passes; gaskets that surround the gas flow plate to prevent the leakage of the gasses; and O-rings that surround the flow channels of the cooling plates and the O-ring beds to prevent the leakage of the cooling water.

The O-ring bed may be formed of an electrical insulator to prevent the electricity from leaking along the cooling water.

One pair of O-ring beds may be combined to each of the gas flow plates; alternately, one O-ring bed may be combined to multiple gas flow plates.

The gas flow plates may comprise bipolar plates on which flow channels are formed on both surfaces of the plates and monopolar plates on which flow channels are formed only on one surface of the plates.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic drawing illustrating the principle of electricity generation in a conventional fuel cell;

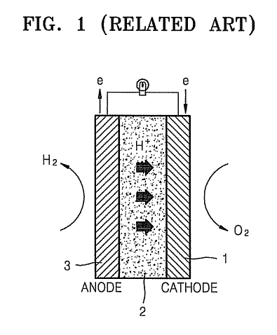

FIG. 2 is an exploded perspective view illustrating a structure of a conventional fuel cell stack;

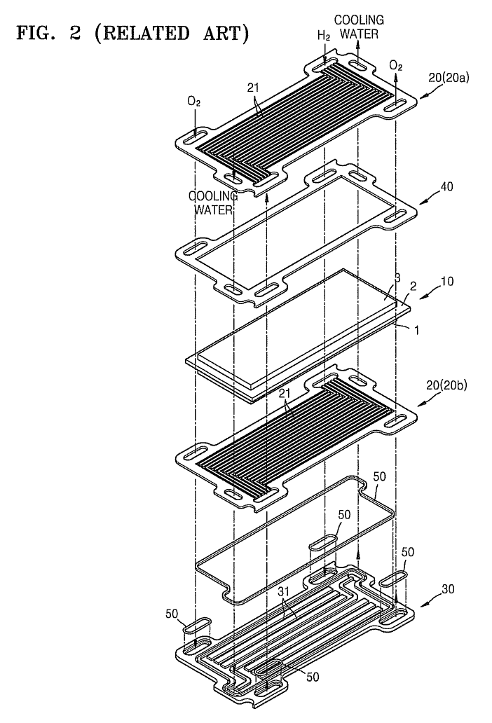

FIG. 3 is an exploded perspective view illustrating a fuel cell stack structure of a fuel cell stack; and

FIG. 4 is an exploded perspective view illustrating a modified fuel cell stack structure of FIG. 3.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. Aspects of the current invention are described below in order to explain the present invention by referring to the figures.

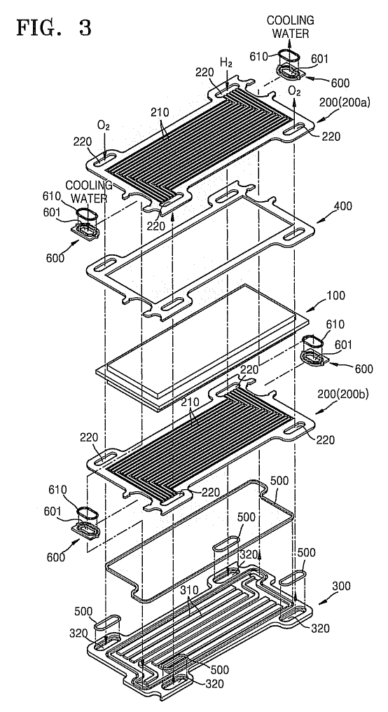

FIG. 3 is an exploded perspective view illustrating a stacked structure of a fuel cell stack having a sealing structure according to aspects of the present invention.

Referring to FIG. 3, the fuel cell stack has a structure in which MEAs 100, gas flow plates 200, and cooling plates 300 are stacked, and gaskets 400 that prevent the leakage of gasses are mounted between the gas flow plates 200, and O-rings 500 that prevent the leakage of cooling water are mounted between the cooling plates 300 and the gas flow plates 200. The gas flow plates 200 include bipolar plates 200a and monopolar plates 200b.

However, in each gas flow plate 200, a portion where the cooling water passes has a completely different structure from that of the conventional structure. That is, in the related art, a hole through which cooling water passes is formed in each of the gas flow plates 20. However, the fuel cell stack according to aspects of the present invention includes a sealing structure that comprises an O-ring bed 600 through which a liquid flow hole 601 extends and an O-ring 610. The O-ring bed 600 is attachable to the gas flow plate 200. That is, the gasket 400 between the gas flow plates 200 specifically performs sealing functions with respect to an inlet 220 and reaction flow channels 210, thereby sealing the gasses that pass therethrough, and an O-ring 610 that surrounds the liquid flow hole 601 in the O-ring bed 600, which performs sealing functions with respect to the cooling water.

In other words, the function of sealing the gasses and the cooling water in the gas flow plates 200 is divided such that the gasket 400 is used to seal portions where the gasses, which have a pressure of approximately 5 kpa pass, and the O-ring 610 that surrounds the liquid flow hole 601 in the O-ring bed 600 is used to seal portions through which the cooling water, which has a pressure of approximately 500 kpa, passes. In this way, the sealing members that meet each pressure condition can be readily manufactured, and the necessity of manufacturing a sealing structure that must withstand a pressure difference of about several hundred kPa is eliminated. O-rings 500 also surround and seal fuel flow holes 320 in the cooling plates 300, which align with the fuel flow holes 200 of the gas flow plates 200.

When electricity is generated using the above fuel cell stack structure, an electrochemical reaction occurs in the MEA 100 between hydrogen and oxygen supplied through reaction flow channels 210 of the gas flow plates 200. The leakage of the gasses can be prevented by the gasket 400. Heat generated by the reaction is cooled by the cooling water that passes through flow channels 310 of the cooling plates 300. When the cooling water passes through the gas flow plates 200, the cooling water passes through the liquid flow holes 601 of the O-ring beds 600. Thus, the leakage of the cooling water is prevented by the O-ring 610 that surrounds the liquid flow hole 601.

The O-ring bed 600 may be formed of an electrical insulator such as plastic. When the O-ring bed 600 is formed of an electrical insulator, the O-ring bed 600 is electrically insulated from the gas flow plates 200, thereby preventing the leakage of electricity generated from the MEA 100 to the cooling water. Furthermore, O-rings 500 and 601 may also be formed of insulative materials to prevent electrical leakage.

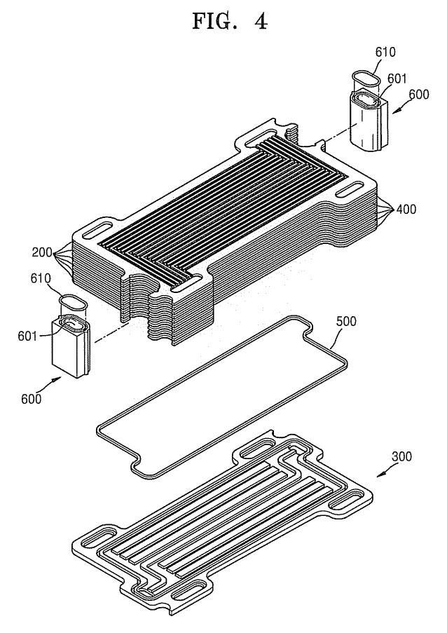

As described above, one pair of O-ring beds 600 is formed in each of the gas flow plates 200. However, as depicted in FIG. 4, a thick O-ring bed 600 that simultaneously binds the multiple gas flow plates 200 and is formed between the cooling plates 300 can be employed. In this way, processes for manufacturing the O-ring beds 600 and combining the O-ring beds 600 with the gas flow plates 200 can be simplified, thereby increasing productivity. However, the O-ring bed 600 may comprise an elongated o-ring that is connectable to a plurality of gas flow plates, such as a combined O-ring bed 600 and o-ring 610 structure that seals the liquid flow therethrough.

The fuel cell stack has a structure similar to that described above, and the gasket 400 seals the gaseous flow in the reaction flow channels 210 in the gas flow plates 200. And, the O-rings 610 mounted on the O-ring beds 600 seal the liquid cooling water flow to and from the cooling plates 300 through the liquid flow holes 601. The above-described fuel cell stack structure increases the efficiency and ease of manufacturing the sealing members and prevents both physical and electrical leakage.

A fuel cell according to the present invention has, among others, the following advantages:

First, since a gasket seals the gasses that have a low pressure of approximately a few kPa, and an O-ring mounted on an additional O-ring bed seals the cooling water, which has a high pressure of approximately a few hundred kPa, the necessity of manufacturing a sealing member that can withstand a pressure difference of almost 100 fold is removed, thereby reducing manufacturing costs of the sealing member.

Second, since the O-ring bed and O-rings through which cooling water passes are formed of an electrical insulator, the leakage of electricity through the cooling water is prevented; thereby further increasing power generation efficiency of the fuel cell.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A fuel cell stack, comprising:
membrane electrode assemblies in which an electricity generating reaction occurs;
gas flow plates on which flow channels to supply gasses to the electrodes are formed;
cooling plates on which cooling flow channels to supply cooling water for removing heat generated from the electricity generating reaction are formed;
O-ring beds that are connectable to the gas flow plates and have a liquid flow hole through which the cooling water passes;
gaskets that surround the gas flow plate to prevent the leakage of the gasses; and
first O-rings that surround the cooling flow channels of the cooling plates and the O-ring beds to prevent the leakage of the cooling water.

2. The fuel cell stack of claim 1, wherein the O-ring beds are formed of an electrical insulator.

3. The fuel cell stack of claim 1, wherein one O-ring bed is connectable to each of the gas flow plates.

4. The fuel cell stack of claim 1, wherein one O-ring bed is connectable to multiple gas flow plates.

5. The fuel cell stack of claim 1, wherein the gas flow plates comprise bipolar plates on which flow channels are formed on both surfaces of the plates and monopolar plates on which flow channels are formed on only one surface of the plates.

6. The fuel cell stack of claim 1, wherein the first O-rings are formed of an electrical insulator.

7. The fuel cell stack of claim 1, further comprising second O-rings sit on the o-ring beds to further prevent leakage of the cooling water from the liquid flow holes.

8. The fuel cell stack of claim 7, wherein the second O-rings are formed of an electrical insulator.

9. A sealing structure for a fuel cell, comprising:
a gasket to seal a gaseous flow in reaction flow channels of gas flow plates;
a first o-ring to seal a liquid flow in flow channels of a cooling plate;
o-ring beds having liquid flow holes and connectable to the gas flow plates; and
second O-rings to seal the liquid flow in the liquid flow holes,
wherein the second O-rings are positioned on the o-ring beds and the second O-rings and the o-ring beds seal the liquid flow between adjacent cooling plates.

10. The sealing structure of claim 9, wherein the o-ring beds are respectively connectable to the gas flow plates.

11. The sealing structure of claim 9, wherein each o-ring bed is connectable to a plurality of the gas flow plates.

12. The sealing structure of claim 11, wherein the plurality of gas flow plates comprises about 5 to 6 gas flow plates.

13. The sealing structure of claim 9, wherein the second O-rings and the o-ring beds are electrically insulative.

14. The sealing structure of claim 9, wherein each o-ring bed is connectable to every gas flow plate disposed between adjacent ones of the cooling plates.

15. The sealing structure of claim 9, further comprising:
third o-rings to seal fuel flow holes that extend through the cooling plates.

16. The sealing structure of claim 13, wherein the third O-rings are electrically insulative.

17. A fuel cell stack, comprising:
membrane electrode assemblies each including an anode, a cathode, and an electrolyte membrane;
gas flow plates to direct a gaseous flow to the membrane electrode assemblies,
wherein the gas flow plates further comprise bipolar plates having reaction flow channels on both sides and monopolar plates having reaction flow channels on only one side;
a cooling plate to supply a liquid flow to the side opposite the reaction flow channels of the monopolar plates; and
a sealing structure to seal the gaseous flow and the liquid flow,
wherein the membrane electrode assemblies are disposed between the gas flow plates, and at least one of the membrane electrode assemblies is disposed between a monopolar plate and a bipolar plate, and the sealing structure is the sealing structure of claim 9.

18. A sealing structure for a fuel cell, comprising:
a gasket to seal a gaseous flow in reaction flow channels of gas flow plates;
o-ring beds having liquid flow holes and connectable to the gas flow plates; and
o-rings to seal the liquid flow in the liquid flow holes,
wherein the o-rings are positioned on the o-ring beds, and the O-rings and the o-ring beds are electrically insulative.

19. A sealing structure for a fuel cell, comprising:
a first seal to seal gaseous flow in the fuel cell, and
a second seal to seal liquid flow in the fuel cell,
wherein the liquid flow exerts a substantially greater pressure on the second seal than the gaseous flow exerts on the first seal.

20. The sealing structure of claim 19, wherein the second seal comprises an o-ring and an o-ring bed.

21. The sealing structure of claim 20, wherein the o-ring bed is connectable to gaseous flow plates and seals the liquid flow therethrough.

22. The sealing structure of claim 19, wherein the second seal comprises an elongated o-ring connectable to a plurality of gaseous flow plates.

23. The sealing structure of claim 22, wherein the elongated o-ring seals the liquid flow from a cooling plate to an adjacent cooling plate.

24. The sealing structure of claim 19, wherein the second seal is electrically insulative.
